(19) United States
(12) Patent Application Publication
(10) Pub. No.: US 2022/0288782 A1
(43) Pub. Date: Sep. 15, 2022

(54) CONTROLLING MULTIPLE SIMULATED ROBOTS WITH A SINGLE ROBOT CONTROLLER

(71) Applicant: X Development LLC, Mountain View, CA (US)

(72) Inventors: Matthew Bennice, San Jose, CA (US); Paul Bechard, San Jose, CA (US)

(21) Appl. No.: 17/197,651

(22) Filed: Mar. 10, 2021

(51) Int. Cl. B25J 9/16

(52) U.S. Cl. CPC B25J 9/1671; B25J 9/163; B25J 9/1664

(57) ABSTRACT

Implementations are provided for controlling a plurality of simulated robots in a virtual environment using a single robot controller. In various implementations, a three-dimensional (3D) environment may be simulated that includes a plurality of simulated robots controlled by a single robot controller. Multiple instances of an interactive object may be rendered in the simulated 3D environment. Each instance of the interactive object may have a simulated physical characteristics such as a pose that is unique among the multiple instances of the interactive object. A common set of joint commands may be received from the single robot controller. The common set of joint commands may be issued to each of the plurality of simulated robots. For each simulated robot of the plurality of simulated robots, the common command may cause actuation of one or more joints of the simulated robot to interact with a respective instance of the interactive object in the simulated 3D environment.

### BACKGROUND

Robots are often equipped with various types of machine learning models that are trained to perform various tasks and/or to enable the robots to engage with dynamic environments. These models are sometimes trained by causing real-world physical robots to repeatedly perform tasks, with outcomes of the repeated tasks being used as training examples to tune the models. However, extremely large numbers of repetitions may be required in order to sufficiently train a machine learning model to perform tasks in a satisfactory manner.

The time and costs associated with training machine learning models through real-world operation of physical robots may be reduced and/or avoided by simulating robot operation in simulated (or “virtual”) environments. For example, a three-dimensional (3D) virtual environment may be simulated with various objects to be acted upon by a robot. The robot itself may also be simulated in the virtual environment, and the simulated robot may be operated to perform various tasks on the simulated objects. The machine learning model(s) can be trained based on outcomes of these simulated tasks. However, a large number of recorded “training episodes”—instances where a simulated robot interacts with a simulated object—may need to be generated in order to sufficiently train a machine learning model such as a reinforcement machine learning model. Much of the computing resources required to generate these training episodes lies in operating a robot controller, whether it be a real-world robot controller (e.g., integral with a real-world robot or operating outside of a robot) or a robot controller that is simulated outside of the virtual environment.

### SUMMARY

Implementations are described herein for controlling a plurality of simulated robots in a virtual environment using a single robot controller. More particularly, but not exclusively, implementations are described herein for controlling the plurality of simulated robots based on common/shared joint commands received from the single robot controller to interact with multiple instances of an interactive object that are simulated in the virtual environment with a distribution of distinct physical characteristics, such as a distribution of distinct poses. Causing the plurality of simulated robots to operate on a corresponding multiple instances of the same interactive object in disjoint world states—e.g., each instance having a slightly different pose or other varied physical characteristic—accelerates the process of creating training episodes. These techniques also provide an efficient way to ascertain measures of tolerance of robot joints (e.g., grippers) and sensors.

In various implementations, the robot controller may generate and issue a set of joint commands based on the state of the robot and/or the state of the virtual environment. The state of the virtual environment may be ascertained via data generated by one or more virtual sensors based on their observations of the virtual environment. In fact, it may be the case that the robot controller is unable to distinguish between operating in the real world and operating in a simulated environment. In some implementations, the state of the virtual environment may correspond to an instance of the interactive object being observed in a “baseline” pose. Sensor data capturing this pose may be what is provided to the robot controller in order for the robot controller to generate the set of joint commands for interacting with the interactive object.

However, in addition to the instance of the interactive object in the baseline pose, a plurality of additional instances of the interactive object may be rendered in the virtual environment as well. A pose of each instance of the interactive object may be altered (e.g., rotated, translated, etc.) relative to poses of other instances of the interactive object, including to the baseline pose. Each of the plurality of simulated robots may then attempt to interact with a respective instance of the interactive object. As mentioned previously, each of the plurality of simulated robots receives the same set of joint commands, also referred to herein as a “common” set of joint commands, that is generated based on the baseline pose of the interactive object. Consequently, each of the plurality of simulated robots operates its joint(s) in the same way to interact with its respective instance of the interactive object.

However, each instance of the interactive object (other than the baseline instance) has a pose that is distinct from poses of the other instances. Consequently, the outcome of these operations may vary depending on a tolerance of the simulated robot (and hence, a real-world robot it simulates) to deviations of the interactive object from what it sensed. Put another way, by holding constant the set of joint commands issued across the plurality of simulated robots, while varying the pose of a respective instance of the interactive object for each simulated robot, it can be determined how much tolerance the simulated robot has for deviations of interactive objects from their expected/observed poses.

In various implementations, various parameters associated with the robot controller may be altered based on outcomes of the same set of joint commands being used to interact with the multiple instances of the interactive object in distinct poses. For example, a machine learning model such as a reinforcement learning policy may be trained based on success or failure of each simulated robot.

In some implementations, the outcomes may be analyzed to ascertain inherent tolerances of component(s) of the robot controller and/or the real-world robot it represents. For example, it may be observed that the robot is able to successfully interact with instances of the interactive object with poses that are within some translational and/or rotational tolerance of the baseline. Outside of those tolerances, the simulated robot may fail.

These tolerances may be subsequently associated with components of the robot controller and/or the real-world robot controlled by the robot controller. For example, the observed tolerance of a particular configuration of a simulated robot arm having a particular type of simulated gripper may be attributed to the real-world equivalents. Alternatively, the tolerances may be taken into account when selecting sensors for the real-world robot. For instance, if the simulated robot is able to successfully operate on instances of the interactive object having poses within 0.5 millimeters of the baseline pose, then sensors that are accurate within 0.5 millimeters may suffice for real-world operation of the robot.

In some implementations, a computer implemented method may be provided that includes: simulating a three-dimensional (3D) environment, wherein the simulated 3D environment includes a plurality of simulated robots controlled by a single robot controller; rendering multiple instances of an interactive object in the simulated 3D environment, wherein each instance of the interactive object has a simulated physical characteristic that is unique among the multiple instances of the interactive object; and receiving, from the robot controller, a common set of joint commands to be issued to each of the plurality of simulated robots, wherein for each simulated robot of the plurality of simulated robots, the common command causes actuation of one or more joints of the simulated robot to interact with a respective instance of the interactive object in the simulated 3D environment.

In various implementations, the robot controller may be integral with a real-world robot that is operably coupled with the one or more processors. In various implementations, the common set of joint commands received from the robot controller may be intercepted from a joint command channel between one or more processors of the robot controller and one or more joints of the real-world robot.

In various implementations, the simulated physical characteristic may be a pose, and the rendering may include: selecting a baseline pose of one of the multiple instances of the interactive object; and for each of the other instances of the interactive object, altering the baseline pose to yield the unique pose for the instance of the interactive object.

In various implementations, the simulated physical characteristic may be a pose, and the method may further include providing sensor data to the robot controller. The sensor data may capture the one of the multiple instances of the interactive object in a1 baseline pose. The robot controller may generate the common set of joint commands based on the sensor data.

In various implementations, the method may include: determining outcomes of the interactions between the plurality of simulated robots and the multiple instances of the interactive object; and based on the outcomes, adjusting one or more parameters associated with operation of one or more components of a real-world robot. In various implementations, adjusting one or more parameters may include training a machine learning model based on the outcomes. In various implementations, the machine learning model may take the form of a reinforcement learning policy.

Other implementations may include a non-transitory computer readable storage medium storing instructions executable by a processor to perform a method such as one or more of the methods described above. Yet another implementation may include a control system including memory and one or more processors operable to execute instructions, stored in the memory, to implement one or more modules or engines that, alone or collectively, perform a method such as one or more of the methods described above.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1A schematically depicts an example environment in which disclosed techniques may be employed, in accordance with various implementations.

FIG. 1B depicts an example robot, in accordance with various implementations.

FIG. 2 schematically depicts an example of how a robot controller may interface with a simulation engine to facilitate generation of a virtual environment that includes robot avatars controlled by the robot controller, in accordance with various implementations.

FIG. 3 depicts an example of how techniques described herein may be employed to render multiple instances of an interactive object in a virtual environment, in accordance with various implementations.

FIG. 4 depicts an example of an acyclic graph that may be used in various implementations to represent a robot and/or its constituent components.

FIG. 5 depicts an example method for practicing selected aspects of the present disclosure.

FIG. 6 schematically depicts an example architecture of a computer system.

### DETAILED DESCRIPTION

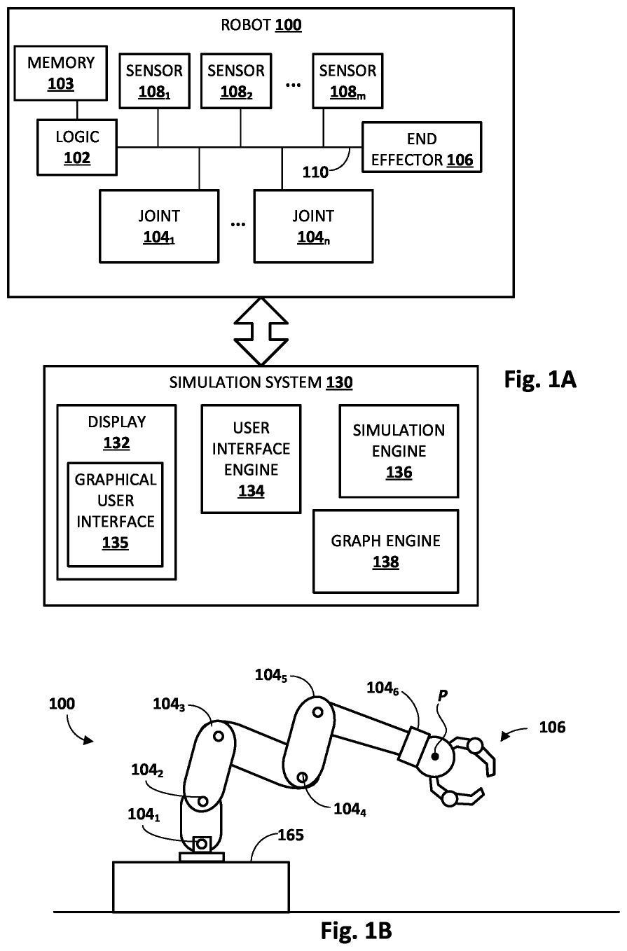

FIG. 1A is a schematic diagram of an example environment in which selected aspects of the present disclosure may be practiced in accordance with various implementations. The various components depicted in FIG. 1A, particularly those components forming a simulation system 130, may be implemented using any combination of hardware and software. In some implementations, simulation system 130 one or more servers forming part of what is often referred to as a “cloud” infrastructure, or simply “the cloud.”

A robot 100 may be in communication with simulation system 130. Robot 100 may take various forms, including but not limited to a telepresence robot (e.g., which may be as simple as a wheeled vehicle equipped with a display and a camera), a robot arm, a humanoid, an animal, an insect, an aquatic creature, a wheeled device, a submersible vehicle, an unmanned aerial vehicle (“UAV”), and so forth. One non-limiting example of a robot arm is depicted in FIG. 1B. In various implementations, robot 100 may include logic 102. Logic 102 may take various forms, such as a real time controller, one or more processors, one or more field-programmable gate arrays (“FPGA”), one or more application-specific integrated circuits (“ASIC”), and so forth. In some implementations, logic 102 may be operably coupled with memory 103. Memory 103 may take various forms, such as random access memory (“RAM”), dynamic RAM (“DRAM”), read-only memory (“ROM”), Magnetoresistive RAM (“MRAM”), resistive RAM (“RRAM”), NAND flash memory, and so forth.

In some implementations, logic 102 may be operably coupled with one or more joints 104₁₋ₙ, one or more end effectors 106, and/or one or more sensors 108₁₋ₘ, e.g., via one or more buses 110. As used herein, “joint” 104 of a robot may broadly refer to actuators, motors (e.g., servo motors), shafts, gear trains, pumps (e.g., air or liquid), pistons, drives, propellers, flaps, rotors, or other components that may create and/or undergo propulsion, rotation, and/or motion. Some joints 104 may be independently controllable, although this is not required. In some instances, the more joints robot 100 has, the more degrees of freedom of movement it may have.

As used herein, “end effector” 106 may refer to a variety of tools that may be operated by robot 100 in order to accomplish various tasks. For example, some robots may be equipped with an end effector 106 that takes the form of a claw with two opposing “fingers” or “digits.” Such as claw is one type of “gripper” known as an “impactive” gripper. Other types of grippers may include but are not limited to “ingressive” (e.g., physically penetrating an object using pins, needles, etc.), “astrictive” (e.g., using suction or vacuum to pick up an object), or “contigutive” (e.g., using surface tension, freezing or adhesive to pick up object). More generally, other types of end effectors may include but are not limited to drills, brushes, force-torque sensors, cutting tools, deburring tools, welding torches, containers, trays, and so forth. In some implementations, end effector 106 may be removable, and various types of modular end effectors may be installed onto robot 100, depending on the circumstances. Some robots, such as some telepresence robots, may not be equipped with end effectors. Instead, some telepresence robots may include displays to render visual representations of the users controlling the telepresence robots, as well as speakers and/or microphones that facilitate the telepresence robot “acting” like the user.

Sensors 108 may take various forms, including but not limited to 3D laser scanners or other 3D vision sensors (e.g., stereographic cameras used to perform stereo visual odometry) configured to provide depth measurements, two-dimensional cameras (e.g., RGB, infrared), light sensors (e.g., passive infrared), force sensors, pressure sensors, pressure wave sensors (e.g., microphones), proximity sensors (also referred to as “distance sensors”), depth sensors, torque sensors, barcode readers, radio frequency identification (“RFID”) readers, radars, range finders, accelerometers, gyroscopes, compasses, position coordinate sensors (e.g., global positioning system, or “GPS”), speedometers, edge detectors, and so forth. While sensors 108₁₋ₘ are depicted as being integral with robot 100, this is not meant to be limiting.

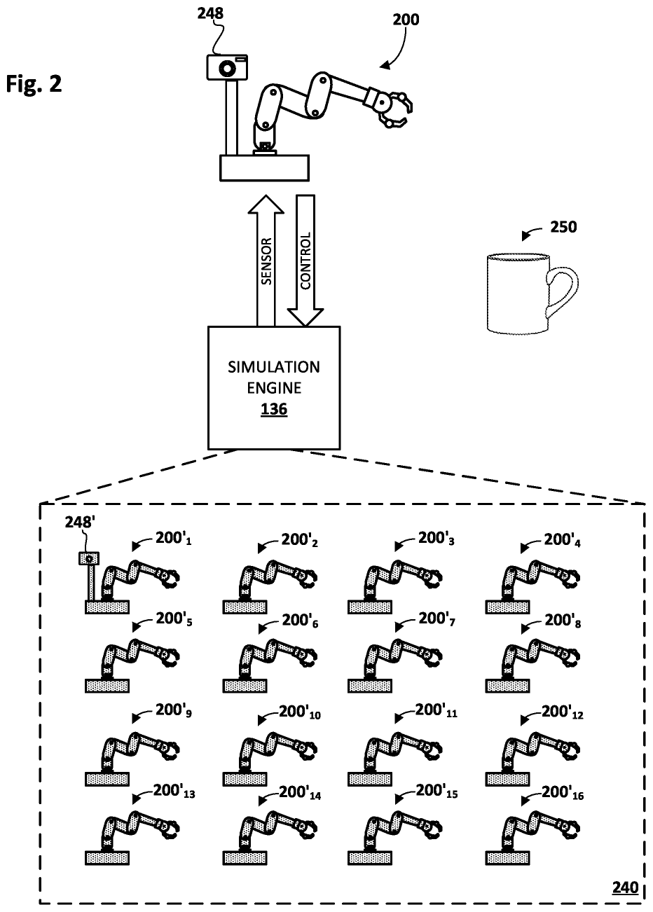

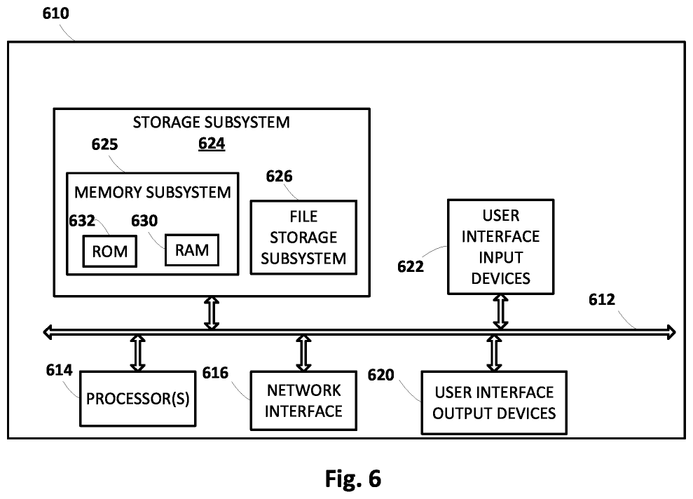

Simulation system 130 may include one or more computing systems connected by one or more networks (not depicted). An example of such a computing system is depicted schematically in FIG. 6. In various implementations, simulation system 130 may be operated to simulate a virtual environment in which multiple robot avatars (not depicted in FIG. 1, see FIG. 2) are simulated. In various implementations, multiple robot avatars may be controlled by a single robot controller. As noted previously, a robot controller may include, for instance, logic 102 and memory 103 of robot 100.

Various modules or engines may be implemented as part of simulation system 130 as software, hardware, or any combination of the two. For example, in FIG. 1A, simulation system 130 includes a display interface 132 that is controlled, e.g., by a user interface engine 134, to render a graphical user interface (“GUI”) 135. A user may interact with GUI 135 to trigger and/or control aspects of simulation system 130, e.g., to control a simulation engine 136 that simulates the aforementioned virtual environment.

Simulation engine 136 may be configured to perform selected aspects of the present disclosure to simulate a virtual environment in which the aforementioned robot avatars can be operated. For example, simulation engine 136 may be configured to simulate a three-dimensional (3D) environment that includes an interactive object. The virtual environment may include a plurality of robot avatars that are controlled by a robot controller (e.g., 102 and 103 of robot 100 in combination) that is external from the virtual environment. Note that the virtual environment need not be rendered visually on a display. In many cases, the virtual environment and the operations of robot avatars within it may be simulated without any visual representation being provided on a display as output.

Simulation engine 136 may be further configured to provide, to the robot controller that controls multiple robot avatars in the virtual environment, sensor data that is generated from a perspective of at least one of the robot avatars that is controlled by the robot controller. As an example, suppose a particular robot avatar's vision sensor is pointed in a direction of a particular virtual object in the virtual environment. Simulation engine 136 may generate and/or provide, to the robot controller that controls that robot avatar, simulated vision sensor data that depicts the particular virtual object as it would appear from the perspective of the particular robot avatar (and more particularly, its vision sensor) in the virtual environment.

Simulation engine 136 may also be configured to receive, from the robot controller that controls multiple robot avatars in the virtual environment, a shared or common set of joint commands that cause actuation of one or more joints of each of the multiple robot avatars that is controlled by the robot controller. For example, the external robot controller may process the sensor data received from simulation engine 136 to make various determinations, such as recognizing an object and/or its pose (perception), and/or planning a path to the object and/or a grasp to be used to interact with the object. The external robot controller may make these determinations and may generate (execution) joint commands for one or more joints of a robot associated with the robot controller.

In the context of the virtual environment simulated by simulation engine 136, this common set of joint commands may be used, e.g., by simulation engine 136, to actuate joint(s) of the multiple robot avatars that are controlled by the external robot controller. Given that the common set of joint commands is provided to each of the robot avatars, it follows that each robot avatar may actuate its joints in the same way. Put another way, the joint commands are held constant across the multiple robot avatars.

In order to generate training episodes that can be used, for instance, to train a reinforcement learning machine learning model, variance may be introduced across the plurality of robot avatars by varying poses of instances of an interactive object being acted upon by the plurality of robot avatars. For example, one “baseline” instance of the interactive object may be rendered in the virtual environment in a “baseline” pose. Multiple other instances of the interactive object may likewise be rendered in the virtual environment, one for each robot avatar. Each instance of the interactive object may be rendered with a simulated physical characteristic, such as a pose, mass, etc., that is unique amongst the multiple instances of the interactive object.

Consequently, even though each robot avatar may actuate its joints in the same way, in response to the common set of joint commands, the outcome of each robot avatar's actuation may vary depending on a respective simulated physical characteristic of the instance of the interactive object the robot avatar acts upon. Simulated physical characteristics of interactive object instances may be varied from each other in various ways. For examples, poses may be varied via translation, rotation (along any axis), and/or repositioning of components that are repositionable. Other physical characteristics, such as size, mass, surface texture, etc., may be altered in other ways, such as via expansion (growth) or contraction. By introducing slight variances between simulated physical characteristics (e.g., poses) of instances of interactive objects, it is possible to ascertain tolerance(s) of components of the robot, such as one or more sensors 108 and/or one or more joints 104.

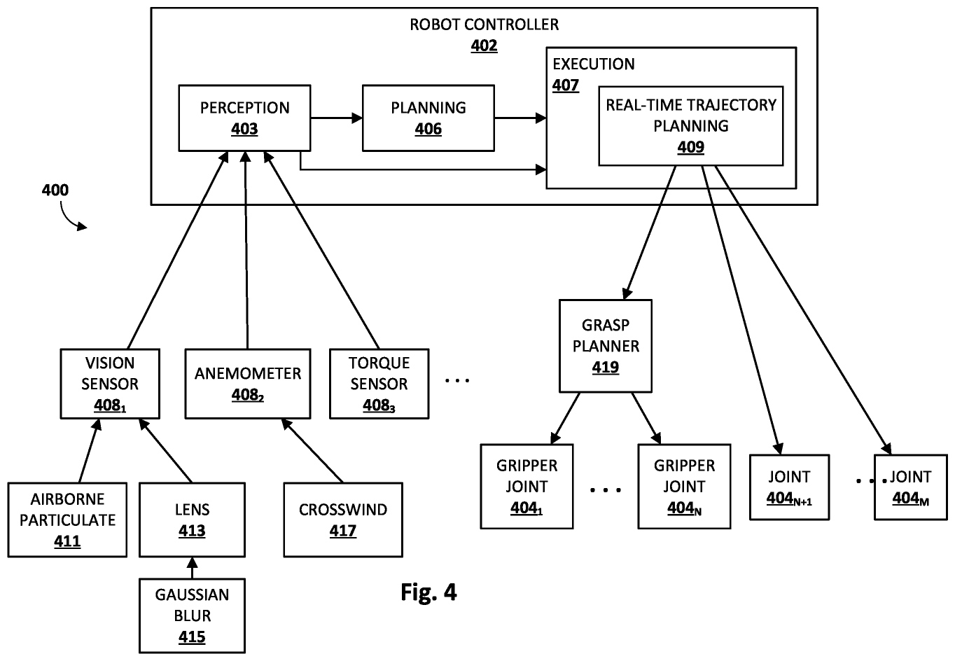

Robot avatars and/or components related thereto may be generated and/or organized for use by simulation engine 136 in various ways. In some implementations, a graph engine 138 may be configured to represent robot avatars and/or their constituent components, and in some cases, other environmental factors, as nodes/edges of graphs. In some implementations, graph engine 138 may generate these graphs as acyclic directed graphs. In some cases these acyclic directed graphs may take the form of dependency graphs that define dependencies between various robot components. An example of such a graph is depicted in FIG. 4.

Representing robot avatars and other components as acyclic directed dependency graphs may provide a variety of technical benefits. One benefit is that robot avatars may in effect become portable in that their graphs can be transitioned from one virtual environment to another. As one non-limiting example, different rooms/areas of a building may be represented by distinct virtual environments. When a robot avatar “leaves” a first virtual environment corresponding to a first room of the building, e.g., by opening and entering a doorway to a second room, the robot avatar's graph may be transferred from the first virtual environment to a second virtual environment corresponding to the second room. In some such implementations, the graph may be updated to include nodes corresponding to environmental conditions and/or factors associated with the second room that may not be present in the first room (e.g., different temperatures, humidity, particulates in the area, etc.).

Another benefit is that components of robot avatars can be easily swapped out and/or reconfigured, e.g., for testing and/or training purposes. For example, to test two different light detection and ranging (“LIDAR”) sensors on a real-world physical robot, it may be necessary to acquire the two LIDAR sensors, physically swap them out, update the robot's configuration/firmware, and/or perform various other tasks to sufficiently test the two different sensors. By contrast, using the graphs and the virtual environment techniques described herein, a LIDAR node of the robot avatar's graph that represents the first LIDAR sensor can simply be replaced with a node representing the second LIDAR sensor.

Yet another benefit of using graphs as described herein is that outside influences on operation of real life robots may be represented as nodes and/or edges of the graph that can correspondingly influence operation of robot avatars in the virtual environment. In some implementations, one or more nodes of a directed acyclic graph may represent a simulated environmental condition of the virtual environment. These environmental condition nodes may be connected to sensor nodes so that the environmental conditions nodes may project or affect their environmental influence on the sensors corresponding to the connected sensor nodes. The sensor nodes in turn may detect this environmental influence and provide sensor data indicated thereof to higher nodes of the graph.

As one non-limiting example, a node coupled to (and therefore configured to influence) a vision sensor may represent particulate, smoke, or other visual obstructions that is present in an area. As another example, a node configured to simulate realistic cross wind patterns may be coupled to a wind sensor node of an unmanned aerial vehicle (“UAV”) avatar to simulate cross winds that might influence flight of a real-world UAV. Additionally, in some implementations, a node coupled to a sensor node may represent a simulated condition of that sensor of the robot avatar. For example, a node connected to a vision sensor may simulate dirt and/or debris that has collected on a lens of the vision sensor, e.g., using Gaussian blur or other similar blurring techniques.

FIG. 1B depicts a non-limiting example of a robot 100 in the form of a robot arm. An end effector 106 in the form of a gripper claw is removably attached to a sixth joint 104₆ of robot 100. In this example, six joints 104₁₋₆ are indicated. However, this is not meant to be limiting, and robots may have any number of joints. Robot 100 also includes a base 165, and is depicted in a particular selected configuration or “pose.”

FIG. 2 schematically depicts one example of how simulation engine 136 may simulate operation of a real-world robot 200 with a plurality of corresponding robot avatars 200′₁₋₁₆ in a virtual environment 240. The real-world robot 200 may operate under various constraints and/or have various capabilities. In this example, robot 200 takes the form of a robot arm, similar to robot 100 in FIG. 1B, but this is not meant to be limiting. Robot 200 also includes a robot controller, not depicted in FIG. 2, which may correspond to, for instance, logic 102 and memory 103 of robot 100 in FIG. 1A. Robot 200 may be operated at least in part based on vision data captured by a vision sensor 248, which may or may not be integral with robot 200.

In the real world (i.e., non-simulated environment), a robot controller may receive, e.g., from one or more sensors (e.g., 108_{1-M}), sensor data that informs the robot controller about a state of the environment in which the robot operates. The robot controller may process the sensor data (perception) to make various determinations and/or decisions (planning) based on the state, such as path planning, grasp selection, localization, mapping, etc. Many of these determinations and/or decisions may be made by the robot controller using one or more machine learning models. Based on these determinations/decisions, the robot controller may provide (execution) joint commands to various joint(s) (e.g., 104₁₋₆ in FIG. 1B) to cause those joint(s) to be actuated.

When a robot controller is coupled with virtual environment 240 simulated by simulation engine 136, a plurality of robot avatars 200′₁₋₁₆ may by operated by the robot controller in a similar fashion. Sixteen robot avatars 200′₁₋₁₆ are depicted in FIG. 2 for illustrative purposes, but this is not meant to be limiting. Any number of robot avatars 200′ may be controlled by the same robot controller. Moreover, there is no requirement that the plurality of avatars 200′₁₋₁₆ are operated either in either parallel or sequentially. In many cases, the robot controller may not be “aware” that it is “plugged into” virtual environment 240 at all, that it is actually controlling virtual joints of robot avatars 200′₁₋₁₆ in virtual environment 240 instead of real joints 104₁₋ₙ, or that joint commands the robot controller generates are provided to multiple different robot avatars 200′₁₋₁₆.

Instead of receiving real-world sensor data from real-world sensors (e.g., 108, 248), simulation engine 136 may simulate sensor data within virtual environment 240, e.g., based on a perspective of one or more of the robot avatars 200′₁₋₁₆ within virtual environment 240. In FIG. 2, for instance, the first robot avatar 200′₁ includes a simulated vision sensor 248′, which is depicted integral with first robot avatar 200′₁ for illustrative purposes only. None of the other robot avatars 200′₂₋₁₆ are depicted with simulated vision sensors because in this example, no sensor data is simulated for them. As shown by the arrows in FIG. 2, this simulated sensor data may be injected by simulation engine 136 into a sensor data channel between a real-world sensor (e.g., 248) of robot 200 and the robot controller that is integral with the robot 200. Thus, from the perspective of the robot controller, the simulated sensor data may not be distinguishable from real-world sensor data.

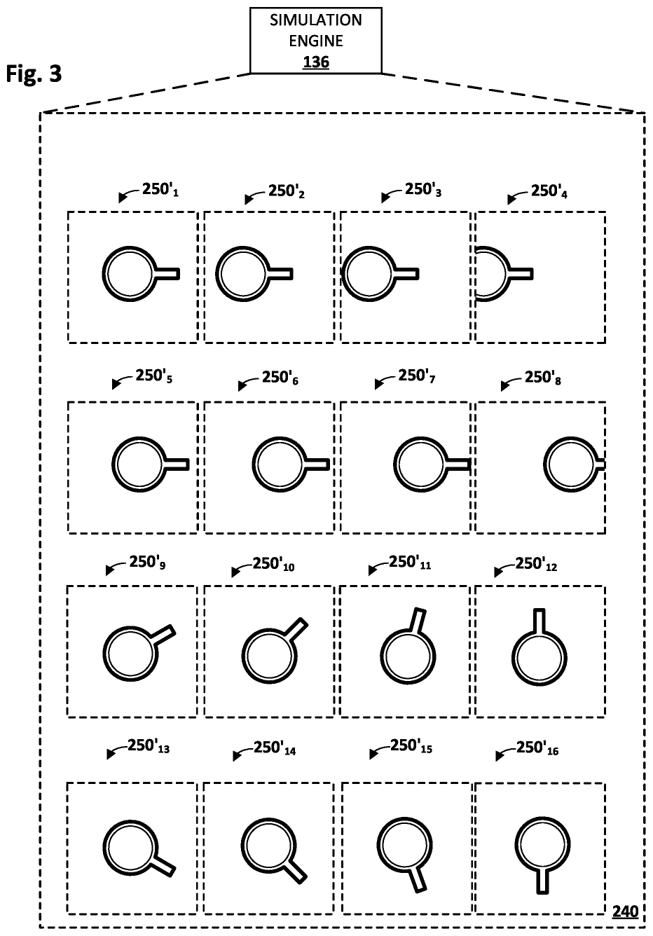

Additionally, and as shown by the arrows in FIG. 2, a common set of joint commands generated by the robot controller based on this sensor data simulated via simulated sensor 248′ is provided to simulation engine 136, which operates joints of robot avatars 200′₁₋₁₆ instead of real robot joints of robot 200. For example, the common set of joint commands received from the robot controller may be intercepted from a joint command channel between the robot controller and one or more joints of robot 200. As will be explained further with respect to FIG. 3, in some implementations, the common set of joint commands generated by the robot controller of robot 200 may cause each of the plurality of robot avatars 200′₁₋₁₆ to operate its simulated joints in the same way to interact with a respective instance of an interactive object having a unique simulated physical characteristic, such as a unique pose. In the example of FIGS. 2-3, this interactive object takes the form of a simulated coffee mug 250 that may be grasped, but this is not meant to be limiting. Interactive objects may take any number of forms, be stationary or portable, etc. Other non-limiting examples of interactive objects that may be employed with techniques described herein include doorknobs, machinery, tools, toys, other dishes, beverages, food trays, lawn care equipment, and so forth.

It is not necessary that a fully-functional robot be coupled with simulation engine 136 in order to simulate robot avatar(s). In some implementations, a robot controller may be executed wholly or partially in software to simulate inputs to (e.g., sensor data) and outputs from (e.g., joint commands) of a robot. Such a simulated robot controller may take various forms, such as a computing device with one or more processors and/or other hardware. A simulated robot controller may be configured to provide inputs and receive outputs in a fashion that resembles, as closely as possible, an actual robot controller integral with a real-world robot (e.g., 200). Thus, for example, the simulated robot controller may output joint commands at the same frequency as they are output by a real robot controller. Similarly, the simulated robot controller may retrieve sensor data at the same frequency as real sensors of a real-world robot. Additionally or alternatively, in some implementations, aspects of a robot that form a robot controller, such as logic 102, memory 103, and/or various busses to/from joints/sensors, may be physically extracted from a robot and, as a standalone robot controller, may be coupled with simulation system 130.

Robots (e.g., 200), standalone robot controllers, and/or simulated robot controllers may be coupled to or “plugged into” virtual environment 240 via simulation engine 136 using various communication technologies. If a particular robot controller or simulated robot controller is co-present with simulation system 130, it may be coupled with simulation engine 136 using one or more personal area networks (e.g., Bluetooth), various types of universal serial bus (“USB”) technology, or other types of wired technology. If a particular robot controller (simulated, standalone, or integral with a robot) is remote from simulation system 130, the robot controller may be coupled with simulation engine 136 over one or more local area and/or wide area networks, such as the Internet.

FIG. 3 depicts an example of how interactive object 250 (coffee mug) may be replicated in a plurality of instances 250′₁₋₁₆, on to be acted upon (e.g., grasped, picked up, filled with liquid, etc.) by each robot avatar 200′ of FIG. 2. In FIG. 3, simulation engine 136 renders, in virtual environment 240, the multiple instances 250′₁₋₁₆ with a distribution of unique poses. At top right, the first instance 250′₁ is rendered in the center of a dashed box (e.g., representing a field of view of simulated vision sensor 248′) with the handle oriented towards the right. This will be referred to herein as the “baseline” pose because it is this pose that will be captured by simulated vision sensor 248′ of first robot avatar 200′₁. The vision sensor data obtained via simulated vision sensor 248′ that captures this baseline pose will be used by the robot controller to generate the common set of joint commands, which are generated to cause robot avatar 200′₁ to interact with this instance 250′₁ of the coffee mug in its particular pose.

In various implementations, each instance 250′ of the interactive object may be rendered with a pose (or more generally, a simulated physical characteristic) that is varied from the rendered poses of the other instances. For example, in the first row of FIG. 3, second instance 250′₂ is translated slightly to the left relative to the baseline pose of first instance 250′₁. Third instance 250′₃ is translated slightly further to the left than second instance 250′₂. And fourth instance 250′₄ is translated slightly further to the left than third instance 250′₃.

The opposite is true in the second row. Fifth instance 250′₅ is translated slightly to the right relative to the baseline pose of first instance 250′₁. Sixth instance 250′₆ is translated slightly to the right relative to fifth instance 250′₅. Seventh instance 250′₇ is translated slightly to the right relative to sixth instance 250′₆. And eighth instance 250′₈ is translated slightly to the right relative to seventh instance 250′₇. Note that there is no significance to the arrangement of translations (or rotations) depicted in FIG. 3; the depicted arrangement is merely for illustrative purposes.

In addition to translation being used to vary poses, in some implementations, poses may be varied in other ways. For example, in the third row of FIG. 3, instances 250′₉₋₁₂ are rotated counterclockwise to various degrees relative to the baseline pose of first instance 250′₁. In the bottom row of FIG. 3, instances 250′₁₃₋₁₆ are rotated clockwise to various degrees relative to the baseline pose of first instance 250′₁. The degrees at which instances 250′ are depicted in FIG. 3 as being rotated and translated relative to each other in FIG. 3 may be exaggerated, e.g., for illustrative purposes; in practice, these translations and/or rotations may or may not be more subtle and/or smaller.

Moreover, while not depicted in FIG. 3, additional instances could be provided with other varied characteristics. For example, additional instances may be rendered with other changes to their poses and/or dimensions, such as being slightly larger or smaller, having different weights or masses, having different surface textures, being filled with liquid to varying degrees, etc.

As noted previously, the robot controller of robot 200 may receive simulated sensor data, e.g., from simulated sensor 248′ of first robot avatar 200′₁, that captures first instance 250′₁ of interactive object 250 in the baseline pose depicted at top left of FIG. 3. Based on this sensor data (e.g., which the robot controller may process as part of a “perception” phase), the robot controller may generate (e.g., as part of a “planning” phase) a set of joint commands. When these joint commands are executed by first robot avatar 200′₁ (e.g., via simulation engine 136) during an “execution” phase, first robot avatar 200′₁ may interact with first instance 250′₁, e.g., by grasping it.

The same or “common” set of joint commands are also used to operate the other robot avatars 200′₂₋₁₆ to interact with the other instances 250′₂₋₁₆ of interactive object 250. For instance, second robot avatar 200′₂ may actuate its joints in the same way to interact with second instance 250′₂ of interactive object 250. Third robot avatar 200′₃ may actuate its joints in the same way to interact with third instance 250′₃ of interactive object 250. And so on.

As the pose of each instance 250′ of interactive object 250 varies to a greater degree from the baseline pose of first instance 250′₁, it is increasingly likely that execution of the common set of joint commands will result in an unsuccessful operation by the respective robot avatar 200′. For example, it may be the case that robot avatars 200′₁₋₃ are able to successfully act upon instances 250′₁₋₃, but fourth robot avatar 200′₄ is unable to successfully act upon fourth instance 250′₄ of interactive object 250 because the variance of the pose fourth instance 250′₄ is outside of a tolerance of robot avatar 200′ (and hence, of real-world robot 200).

The outcomes (e.g., successful or unsuccessful) of robot avatars 200′₁₋₁₆ acting upon instances 250′₁₋₁₆ of interactive object may be recorded, e.g., as training episodes. These training episodes may then be used for various purposes, such as adjusting one or more parameters associated with operation of one or more components of a real-world robot. In some implementations, the outcomes may be used to train a machine learning model such as a reinforcement learning policy, e.g., as part of a reward function. Additionally or alternatively, in some implementations, the outcomes may be used to learn tolerances of robot 200. For example, an operational tolerance of an end effector (e.g., 106) to variations between captured sensor data and reality can be ascertained. Additionally or alternatively, a tolerance of a vision sensor (e.g., 248) may be ascertained. For example, if robot avatars 200′ were successful in acting upon instances 250′ with poses that were translated less than some threshold distance from the baseline pose, a vision sensor having a corresponding resolution capabilities may be usable with the robot (or in the same context).

FIG. 4 depicts an example acyclic directed graph 400 that may be generated, e.g., by graph engine 138 of simulation system 130, in accordance with various implementations. In this example, graph 400 takes the form of a dependency graph that includes nodes that represent constituent components of a robot (not depicted), environmental conditions, conditions of sensors, etc. The particular layout and arrangement of FIG. 4 is not meant to be limiting. Various components depicted in FIG. 4 may be arranged differently relatively to other components in other implementations. Moreover, only a few example components are depicted. Numerous other types of components are contemplated.

Graph 400 includes, as a root node, a robot controller 402 that is external to the virtual environment 240. In other implementations, the robot controller may not be represented as a node, and instead, a root node may act as an interface between the robot controller and children nodes (which may represent sensors and/or other robot controllers simulated in the virtual environment). Robot controller 402 may be implemented with various hardware and software, and may include components such as logic 102, memory 103, and in some cases, bus(ses) from FIG. 1A. From a logical standpoint, robot controller 402 may include a perception module 403, a planning module 406, and an execution module 407. While shown as part of a root node in FIG. 4, in some implementations, one or more of these modules 403, 406, 407 may be represented as its own standalone node that is connected to other node(s) via edge(s). Modules 403, 406, and/or 407 may operate in part using machine learning models such as object recognition modules, models to aid in path planning, models to aid in grasp planning, etc. One or more of these machine learning models may be trained using training data that is generated by operating multiple robot avatars in a single virtual environment, as described herein.

Perception module 403 may receive sensor data from any number of sensors. In the real world, this sensor data may come from real life sensors of the robot in which robot controller 402 is integral. In virtual environment 240, this sensor data may be simulated by and propagated up from various sensor nodes 408₁, 408₂, 408₃, . . . that represent virtual sensors simulated by simulation engine 136. For example, a vision sensor 408₁ may provide simulated vision data, an anemometer 408₂ may provide simulated data about wind speed, a torque sensor 408₃ may provide simulated torque data captured at, for example, one or more robot joints 404, and so forth.

In some implementations, simulated environmental conditions may also be represented as nodes of graph 400. These environmental conditions may be propagated up from their respective nodes to the sensor(s) that would normally sense them in real life. For example, airborne particulate (e.g., smoke) that is desired to be simulated in virtual environment 240 may be represented by an airborne particulate node 411. In various implementations, aspects of the desired airborne particulate to simulate, such as its density, particle average size, etc., may be configured into node 411, e.g., by a user who defines node 411.

In some implementations, aside from being observed by a sensor, an environmental condition may affect a sensor. This is demonstrated by Gaussian blur node 415, which may be configured to simulate an effect of particulate debris collected on a lens of vision sensor 408₁. To this end, in some implementations, the lens of vision senor 408₁ may be represented by its own node 413. In some implementations, having a separate node for a sensor component such as a lens may enable that component to be swapped out and/or configured separately from other components of the sensor. For example, a different lens could be deployed on vision sensor node 408₁ by simply replacing lens node 413 with a different lens node having, for instance, a different focal length. Instead of the arrangement depicted in FIG. 4, in some implementations, airborne particular node 411 may be a child node of lens node 413.

As another example of an environmental condition, suppose the robot represented by graph 400 is a UAV that is configured to, for instance, pickup and/or deliver packages. In some such implementations, a crosswind node 417 may be defined that simulates crosswinds that might be experienced, for instance, when the UAV is at a certain altitude, in a particular area, etc. By virtue of the crosswind node 417 being a child node of anemometer node 408₂, the simulated cross winds may be propagated up, and detected by, the anemometer that is represented by node 408₂.

Perception module 403 may be configured to gather sensor data from the various simulated sensors represented by nodes 408₁, 408₂, 408₃, . . . during each iteration of robot controller 402 (which may occur, for instance, at a robot controller's operational frequency). Perception module 403 may then generate, for instance, a current state. Based on this current state, planning module 406 and/or execution module 407 may make various determinations and generate joint commands to cause joint(s) of the robot avatar represented by graph 400 to be actuated.

Planning module 406 may perform what is sometimes referred to as “offline” planning to define, at a high level, a series of waypoints along a path for one or more reference points of a robot to meet. Execution module 407 may generate joint commands, e.g., taking into account sensor data received during each iteration, that will cause robot avatar joints to be actuated to meet these waypoints (as closely as possible). For example, execution module 407 may include a real-time trajectory planning module 409 that takes into account the most recent sensor data to generate joint commands. These joint commands may be propagated to various simulated robot avatar joints 404_{1-M} to cause various types of joint actuation.

In some implementations, real-time trajectory planning module 409 may provide data such as object recognition and/or pose data to a grasp planner 419. Grasp planner 419 may then generate and provide, to gripper joints 404_{1-N}, joint commands that cause a simulated robot gripper to take various actions, such as grasping, releasing, etc. In other implementations, grasp planner 419 may not be represented by its own node and may be incorporated into execution module 407. Additionally or alternatively, real-time trajectory planning module 409 may generate and provide, to other robot joints 404_{N+1 to M} , joint commands to cause those joints to actuate in various ways.

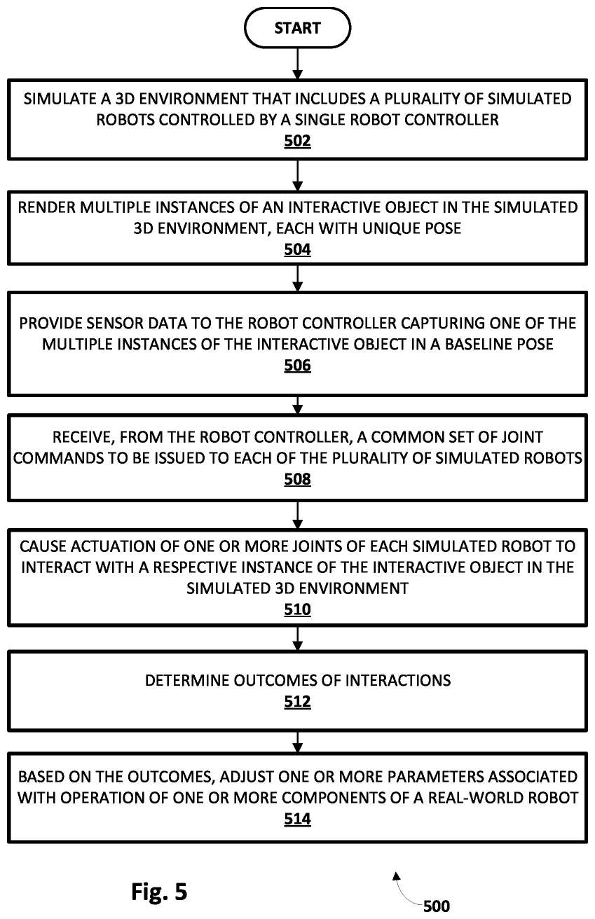

Referring now to FIG. 5, an example method 500 of practicing selected aspects of the present disclosure is described. For convenience, the operations of the flowchart are described with reference to a system that performs the operations. This system may include various components of various computer systems. For instance, some operations may be performed at robot 100, while other operations may be performed by one or more components of simulation system 130. Moreover, while operations of method 500 are shown in a particular order, this is not meant to be limiting. One or more operations may be reordered, omitted or added.

At block 502, the system, e.g., by way of simulation engine 136, may simulate a three-dimensional (3D) environment. The simulated 3D environment may include a plurality of simulated robots (e.g., robot avatars 200′₁₋₁₆ in FIG. 2) controlled by a single robot controller (e.g., 102/103 in FIG. 1A, 402 in FIG. 4). As noted previously, this simulated or virtual environment need not necessarily be displayed on a computer display (2D or 3D), although it can be.

At block 504, the system, e.g., by way of simulation engine 136, may render multiple instances (e.g., 250′₁₋₁₆ in FIG. 3) of an interactive object in the simulated 3D environment. Each instance of the interactive object may be rendered in having a simulated physical characteristic such as a pose that is unique among the multiple instances of the interactive object. As noted above, “rendering” as used herein does not require rendition on a display. Rather, it simply means to generate a simulated instance of the interactive object in the simulated 3D environment that can be acted upon by simulated robot(s). In some implementations, the rendering of block 504 may include, for instance, selecting a baseline pose (or more generally, a baseline simulated physical characteristic) of one (e.g., 250′₁) of the multiple instances of the interactive object, and, for each of the other instances (e.g., 250′₂₋₁₆) of the interactive object, altering the baseline pose to yield the unique pose for the instance of the interactive object.

At block 506, the system, e.g., by way of simulation engine 136, may provide sensor data to the robot controller. In some such implementations, the sensor data may capture the one of the multiple instances (e.g., 250′₁) of the interactive object in the baseline pose. The robot controller may generate the common set of joint commands based on this sensor data.

At block 508, the system, e.g., by way of simulation engine 136, may receive, from the robot controller, a common set of joint commands to be issued to each of the plurality of simulated robots. At block 510, the system, e.g., by way of simulation engine 136, may cause actuation of one or more joints of each simulated robot to interact with a respective instance of the interactive object in the simulated 3D environment.

At block 512, the system, e.g., by way of simulation engine 136, may determine outcomes (e.g., successful, unsuccessful) of the interactions between the plurality of simulated robots and the multiple instances of the interactive object. Based on the outcomes, at block 514, the system may adjust one or more parameters associated with operation of one or more components of a real-world robot. For example, tolerance(s) may be ascertained and/or reinforcement learning policies may be trained.

FIG. 6 is a block diagram of an example computer system 610. Computer system 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computer system 610. Network interface subsystem 616 provides an interface to outside networks and is coupled to corresponding interface devices in other computer systems.

User interface input devices 622 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 610 to the user or to another machine or computer system.

Storage subsystem 624 stores programming and data constructs that provide the functionality of some or all of the modules described herein. For example, the storage subsystem 624 may include the logic to perform selected aspects of method 500, and/or to implement one or more aspects of robot 100 or simulation system 130. Memory 625 used in the storage subsystem 624 can include a number of memories including a main random access memory (RAM) 630 for storage of instructions and data during program execution and a read only memory (ROM) 632 in which fixed instructions are stored. A file storage subsystem 626 can provide persistent storage for program and data files, and may include a hard disk drive, a CD-ROM drive, an optical drive, or removable media cartridges. Modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computer system 610 communicate with each other as intended. Although bus subsystem 612 is shown schematically as a single bus, alternative implementations of the bus subsystem may use multiple busses.

Computer system 610 can be of varying types including a workstation, server, computing cluster, blade server, server farm, smart phone, smart watch, smart glasses, set top box, tablet computer, laptop, or any other data processing system or computing device. Due to the ever-changing nature of computers and networks, the description of computer system 610 depicted in FIG. 6 is intended only as a specific example for purposes of illustrating some implementations. Many other configurations of computer system 610 are possible having more or fewer components than the computer system depicted in FIG. 6.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A method implemented using one or more processors, comprising:
simulating a three-dimensional (3D) environment, wherein the simulated 3D environment includes a plurality of simulated robots controlled by a single robot controller;
rendering multiple instances of an interactive object in the simulated 3D environment, wherein each instance of the interactive object has a simulated physical characteristic that is unique among the multiple instances of the interactive object; and
receiving, from the robot controller, a common set of joint commands to be issued to each of the plurality of simulated robots, wherein for each simulated robot of the plurality of simulated robots, the common command causes actuation of one or more joints of the simulated robot to interact with a respective instance of the interactive object in the simulated 3D environment.

2. The method of claim 1, wherein the robot controller is integral with a real-world robot that is operably coupled with the one or more processors.

3. The method of claim 2, wherein the common set of joint commands received from the robot controller are intercepted from a joint command channel between one or more processors of the robot controller and one or more joints of the real-world robot.

4. The method of claim 1, wherein the simulated physical characteristic comprises a pose, and the rendering comprises:
selecting a baseline pose of one of the multiple instances of the interactive object; and
for each of the other instances of the interactive object, altering the baseline pose to yield the unique pose for the instance of the interactive object.

5. The method of claim 1, wherein the simulated physical characteristic comprises a pose, and the method further comprises providing sensor data to the robot controller, wherein the sensor data captures the one of the multiple instances of the interactive object in a baseline pose, wherein the robot controller generates the common set of joint commands based on the sensor data.

6. The method of claim 1, further comprising:
determining outcomes of the interactions between the plurality of simulated robots and the multiple instances of the interactive object; and
based on the outcomes, adjusting one or more parameters associated with operation of one or more components of a real-world robot.

7. The method of claim 6, wherein adjusting one or more parameters comprises training a machine learning model based on the outcomes.

8. The method of claim 7, wherein the machine learning model comprises a reinforcement learning policy.

9. A system comprising one or more processors and memory storing instructions that, in response to execution of the instructions by the one or more processors, cause the one or more processors to:
simulate a three-dimensional (3D) environment, wherein the simulated 3D environment includes a plurality of simulated robots controlled by a single robot controller;
render multiple instances of an interactive object in the simulated 3D environment, wherein each instance of the interactive object has a pose that is unique among the multiple instances of the interactive object; and
receive, from the robot controller, a common set of joint commands to be issued to each of the plurality of simulated robots, wherein for each simulated robot of the plurality of simulated robots, the common command causes actuation of one or more joints of the simulated robot to interact with a respective instance of the interactive object in the simulated 3D environment.

10. The system of claim 1, wherein the robot controller is integral with a real-world robot that is operably coupled with the one or more processors.

11. The system of claim 10, wherein the common set of joint commands received from the robot controller are intercepted from a joint command channel between one or more processors of the robot controller and one or more joints of the real-world robot.

12. The system of claim 9, comprising instructions to:
select a baseline pose of one of the multiple instances of the interactive object; and
for each of the other instances of the interactive object, alter the baseline pose to yield the unique pose for the instance of the interactive object.

13. The system of claim 9, further comprising instructions to provide sensor data to the robot controller, wherein the sensor data captures the one of the multiple instances of the interactive object in a baseline pose, wherein the robot controller generates the common set of joint commands based on the sensor data.

14. The system of claim 9, further comprising instructions to:
determine outcomes of the interactions between the plurality of simulated robots and the multiple instances of the interactive object; and
based on the outcomes, adjust one or more parameters associated with operation of one or more components of a real-world robot.

15. The system of claim 14, comprising instructions to train a machine learning model based on the outcomes.

16. The system of claim 15, wherein the machine learning model comprises a reinforcement learning policy.

17. At least one non-transitory computer-readable medium comprising instructions that, in response to execution of the instructions by one or more processors, cause the one or more processors to:
simulate a three-dimensional (3D) environment, wherein the simulated 3D environment includes a plurality of simulated robots controlled by a single robot controller;
render multiple instances of an interactive object in the simulated 3D environment, wherein each instance of the interactive object has a pose that is unique among the multiple instances of the interactive object; and
receive, from the robot controller, a common set of joint commands to be issued to each of the plurality of simulated robots, wherein for each simulated robot of the plurality of simulated robots, the common command causes actuation of one or more joints of the simulated robot to interact with a respective instance of the interactive object in the simulated 3D environment.

18. The at least one non-transitory computer-readable medium of claim 17, wherein the robot controller is integral with a real-world robot that is operably coupled with the one or more processors.

19. The at least one non-transitory computer-readable medium of claim 18, wherein the common set of joint commands received from the robot controller are intercepted from a joint command channel between one or more processors of the robot controller and one or more joints of the real-world robot.

20. The at least one non-transitory computer-readable medium of claim 17, comprising instructions to:
select a baseline pose of one of the multiple instances of the interactive object; and
for each of the other instances of the interactive object, alter the baseline pose to yield the unique pose for the instance of the interactive object.
